(19) United States
(12) Patent Application Publication
(10) Pub. No.: US 2023/0227201 A1
(43) Pub. Date: Jul. 20, 2023

(54) FOOD TRAY APPARATUS AND METHODS

(71) Applicant: MIDLAND PAPER COMPANY, Wheeling, IL (US)

(72) Inventors: James NOWAK, Elk Grove Village, IL (US); David F. KARI, Bloomingdale, IL (US)

(21) Appl. No.: 18/152,538

(22) Filed: Jan. 10, 2023

Related U.S. Application Data
(60) Provisional application No. 63/298,115, filed on Jan. 10, 2022.
(60) Provisional application No. 63/407,517, filed on Sep. 16, 2022.

(51) Int. Cl. B65D 5/20; B65D 65/46; B65D 5/64; B65D 5/56

(52) U.S. Cl. CPC B65D 5/20; B65D 65/466; B65D 5/64; B65D 5/563; B65D 2565/385

(57) ABSTRACT

Food tray and food related features that provide a structure having a rounded corner appearance and assembly by mechanical folding are provided, among other features. The tray can have a flap directed adjacent and continuing from a series of triangles formed by fold lines wherein the flap is positioned to have a surface that is flush with the surface of an adjacent sidewall when assembled. A series of tab are positioned above the triangles and when assembled the outer edges of the triangles adjoin the tray sidewalls to close the junctions. A heat and pressure process adheres the adjacent surface. The tray can be made from material is recyclable, compostable and/or biodegradable.

### CROSS-REFERENCE TO RELATED APPLICATION(S)

This application claims priority under 35 U.S.C. § 119(e) to U.S. Provisional Application No. 63/298,115, filed Jan. 10, 2022, and to U.S. Provisional Application No. 63/407,517, filed Sep. 16, 2022, the disclosure of each of which is incorporated herein by reference in its entirety.

### BACKGROUND

### Technical Field

The present disclosure is directed to trays and food trays.

### Description of the Related Art

Single-use plastics are particularly prevalent in the food industry. From straws and utensils to food storage containers, food preparation containers, beverage storage containers, and beverage preparation containers, many products in the food and beverage industry are non-biodegradable and/or non-recyclable and increase the amount of plastics being dumped into the environment. Unfortunately, these materials are relatively easy and cheap to manufacture, leading to their widespread use.

While cost is an important aspect in the manufacture and design of food storage and preparation containers, function is also an important aspect. If a food tray is to hold hot foods, or is to be used in the preparation (e.g., cooking) of foods, the food tray needs to include materials which are configured to withstand the high temperatures needed to perform the desired functions. If a food tray is to hold cold or frozen foods, or is to be kept in a refrigeration unit (e.g., a refrigerator and/or freezer), the food tray need to include materials which are configured to withstand the low temperatures needed to perform the desired functions. Designing a food tray with recyclable, biodegradable, and/or compostable materials that do not enable the food tray to perform its desired function would result in an ineffective food tray since it could not reasonably be used.

Other technical problems or aspects are related to the structure and arrangement of the tray such that it is structured for use in consumer food applications, and it is mechanically arranged to be easily manufactured and distributed. For example, some consumer applications require large high-volume production of trays. Complicated construction of paperboard or similar structure can lead to production failure and reductions in production speed. The functionality and usability of the area that is adapted to receive the food should be such that it provides convenient access and ease of removal of the food. In some cases, sharp edges can make the use less functional. In production the corners or curvatures can lead to leaks or structural issues.

For at least some of these reasons and other reasons, trays or food trays are needed that are efficient to manufacture and use in storing or consuming foods (e.g., hot foods, shelf-stable foods, and frozen, pre-packaged meals) and/or are recyclable, biodegradable and/or compostable.

### SUMMARY OF THE INVENTION

In accordance with principles of the present invention, one or more food trays and related features and methods are provided. A food tray (e.g., a paper food try for consumer us with frozen or refrigerated foods), can include a base portion. The base portion can include a plurality of side walls, configured to form a receptacle for receiving one or more items, and a plurality of corner portions, each corner portion comprising: a plurality of triangular corner folds configured to cause each corner portion to have a generally rounded appearance; and a plurality of cut extension portions extending from the plurality of triangular corner folds. The tray can include an edge cover portion, secured to a top surface of the base portion along an outer perimeter of the base portion, wherein the edge cover portion is configured to be secured to the base portion along the plurality of cut extension portions, covering all or a portion of a top surface of the plurality of cut extension portions. The base portion or the edge cover portion comprises a base substrate, and the base substrate comprises paper board adapted to be folded to form the food tray and is recyclable, compostable, and biodegradable.

The food tray can include a base portion that includes a plurality of edge portions extending from the plurality of side walls, and the edge cover portion is configured to cover all or part of a top surface of the plurality of corner portions and the plurality of edge portions.

The food tray can comprise one or more outer flaps extending from the plurality of corner portions.

The food tray can include a securing means for securing each of the one or more outer flaps to an adjacent side wall, forming the receptacle.

The food tray can include a securing means for securing the edge cover portion to the base portion, wherein the securing means comprises one or more of: an adhesive material, a cohesive material, a heat seal, and an ultrasonic seal. The food tray can include securing means that comprises one or more materials which are compostable.

The food tray can include a lid portion secured to a top surface of the edge cover portion. The lid portion can be secured to the top surface of the edge cover portion using an adhesive material, a cohesive material, a heat seal, or an ultrasonic seal. The securing means can comprise one or more materials which are one or more of: recyclable; biodegradable; and compostable. The lid portion can be configured to be removable from, and resealable to, the top surface of the edge cover portion.

The base portion and the edge cover portion are one or more of: recyclable, biodegradable, and compostable.

The base portion or the edge cover portion can comprise a base substrate and a coating coupled to at least one surface. The coating can be configured to prevent the base substrate from absorbing one or more liquids. The coating comprises one or more materials which are compostable.

The base substrate comprises cellulose. The base substate can be made of cellulose. The base substrate can comprise or be solid bleached sulfate paperboard.

The food tray can have a base portion that is configured for use in one or more of: an oven and a microwave. The base portion can be one that is configured for use in one or more of: a refrigerator; and a freezer.

In one or more embodiments, a food tray comprises a base portion, comprising: a plurality of side walls, configured to form a receptacle for receiving one or more items; and a plurality of corner portions, each corner portion comprising: a plurality of triangular corner folds configured to cause each corner portion to have a generally rounded appearance; and a plurality of cut extension portions extending from the plurality of triangular corner folds; and an edge cover portion, secured to a top surface of the base portion along an outer perimeter of the base portion, wherein the edge cover portion is configured to be secured to the base portion along the plurality of cut extension portions, covering all or a portion of a top surface of the plurality of cut extension portions, wherein the base portion or the edge cover portion comprises a base substrate.

The base portion cam includes a plurality of edge portions extending from the plurality of side walls, and the edge cover portion is configured to cover all or part of a top surface of the plurality of corner portions and the plurality of edge portions. The food tray can include one or more outer flaps extending from the plurality of corner portions. The food tray can comprise a securing means for securing each of the one or more outer flaps to an adjacent side wall, forming the receptacle. The food tray comprising a securing means for securing the edge cover portion to the base portion, wherein the securing means comprises one or more of: an adhesive material; a cohesive material; a heat seal; and an ultrasonic seal. The food tray can be adapted wherein the securing means comprises one or more materials which are compostable. The food tray of claim comprising a lid portion secured to a top surface of the edge cover portion. A securing means included for securing the lid portion to the top surface of the edge cover portion, wherein the securing means comprises one or more of: an adhesive material; a cohesive material; a heat seal; and an ultrasonic seal. The securing means comprising one or more materials which are one or more of: recyclable; biodegradable; and compostable. The lid portion may be configured to be removable from, and resealable to, the top surface of the edge cover portion. The base portion and the edge cover portion are one or more of: recyclable; biodegradable; and compostable. The base portion or the edge cover portion comprising: a base substrate; and a coating coupled to at least one surface. The base substrate comprises, is made of or is cellulose. The base substrate comprises, is made or of is solid bleached sulfate paperboard (SBS). The food tray including a coating is configured to prevent the base substrate from absorbing one or more liquids. The coating comprising one or more materials which are compostable. The base portion is configured for use in one or more of: an oven; and a microwave. The base portion is configured for use in one or more of: a refrigerator; and a freezer. The lid portion can be perforated to provide a tear along an interior area of the lid. The perforated lid portion comprises a notch along an edge portion of the lid to pull and initiate the tearing of the lid. A card piece can be attached to the bottom of the base portion that overhangs to allow the food tray to stand vertically. The food tray wherein the lid portion comprise an extended lid that folds around and attaches to base portion to allow the food tray to stand vertically along the lid extension. The lid portion can be perforated to provide a tear along an interior area of the lid. The perforated lid portion can comprise a notch at an edge portion of the lid to pull and initiate the tearing of the lid.

The food tray can be adapted to have at each bottom corner of the tray, a leak resistance structure comprising terminating a cut line of a sidewall a short distance away from the vertex.

The food tray cam include a plurality of leak resistance arrangements that provide an offset of a terminating end of a cut line at a position a short distance away from a vertex of a corner or fold.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 depicts a top perspective view of a food tray, according to various embodiments of the present invention;

FIG. 2 depicts a top view of a food tray, according to various embodiments of the present invention;

FIG. 3 depicts a bottom view of a food tray, according to various embodiments of the present invention;

FIG. 4 depicts a partial top perspective view of a food tray, according to various embodiments of the present invention;

FIG. 5 depicts a partial bottom perspective view of a food tray, according to various embodiments of the present invention;

FIG. 6 depicts an unassembled view of a food tray, according to various embodiments of the present invention;

FIG. 7 depicts a flow diagram depicting a food tray in various stages of production, according to various embodiments of the present invention;

FIG. 8 depicts a flow diagram depicting a food tray in various stages of production, according to various embodiments of the present invention;

FIGS. 9 (flat die line structure) and FIGS. 10-14 depicts a diagram and images a food tray in accordance with various embodiments of the present invention;

FIG. 15 depicts a flat die line structure diagram of a food tray in accordance with various embodiments of the present invention;

FIG. 16 depicts a flat die line structure diagram of a food tray in accordance with various embodiments of the present invention;

FIG. 17 depicts a partial view of a food tray according to various embodiments of the present invention;

FIGS. 18-19 depict flow diagrams depicting food trays in various stages of production;

FIGS. 20(a) and 20(b) depict (a) a bottom view and (b) a side view images for a food tray according to various embodiment of the present invention;

FIG. 21 depicts flow diagram depicting a food tray in various stages of production, according to various embodiments of the present invention;

FIG. 22(a) and FIG. 22(b) depict (a) a bottom view and (b) a side view images for a food tray according to various embodiment of the present invention; and,

FIG. 23 depicts flow diagram depicting a food tray in various stages of production, according to various embodiments of the present invention.

### DETAILED DESCRIPTION

Like numerals refer to like elements throughout the specification. Not all elements of embodiments of the present disclosure will be described, and description of what are commonly known in the art or what overlap each other in the embodiments will be omitted. The terms as used throughout the specification, such as a plurality of “portions” may be implemented in a single element, or a single “portion” or may include a plurality of elements.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements.

It will be further understood that the term “couple” or its derivatives refer both to direct and indirect connection.

Hereinafter, some embodiments of the present disclosure will be described in detail with reference to the exemplary drawings. In the drawings, the same reference numerals will be used throughout to designate the same or equivalent elements. In addition, a detailed description of well-known features or functions will be ruled out in order not to unnecessarily obscure the gist of the present disclosure.

There has been a significant amount of work directed to making substantial improvements in sustainability in the field of packaging for frozen or refrigerated foods. The most common example of such products are prepared frozen meals that are in the grocery store frozen food aisles. The containers for such foods are adapted to received food contents that can be greasy or wet and adapted to allow the consumer to heat and eat directly from the package (typically a food tray that supports the meal). Embodiments of the present invention as illustratively described herein disclose paper or cellulose trays that are made from a substrate that is recyclable, biodegradable, and/or compostable and is mechanically assembled (folded) from a configured blank and bound by the use of heat and pressure to the assembled tray. The arrangement of the folds, walls, edges, corners or other structural features as illustratively disclosed herein in assembled form provide leak resistant or leak proof trays for serving liquids and/or other foods. Preferably, the heat sealed substrate is adapted to be exposed to consumer oven temperatures such as 350 Degrees Fahrenheit for a period of about 30 minutes without structural deformation such as bending or fire. Similarly the tray is able to be used in the microwave oven and be in the refrigerator or freezer for prolonged periods. In most embodiments, the tray arrangement is a structure that is both easy and quick to form and leak resistant or leak proof (due to the way the tray is mechanically structured and/or the materials from which the substrate is made).

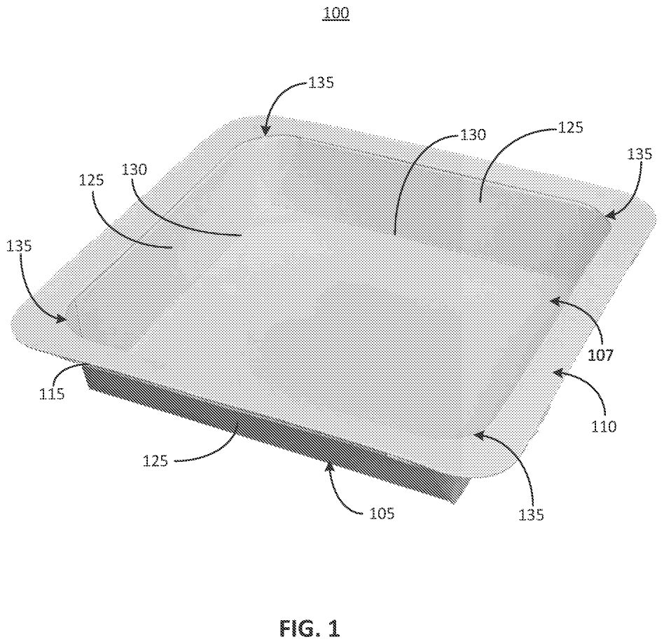

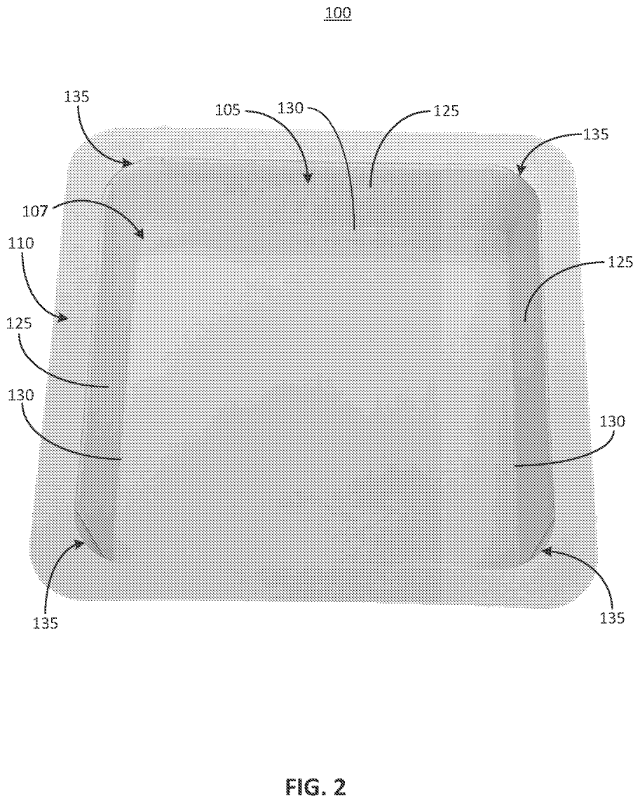

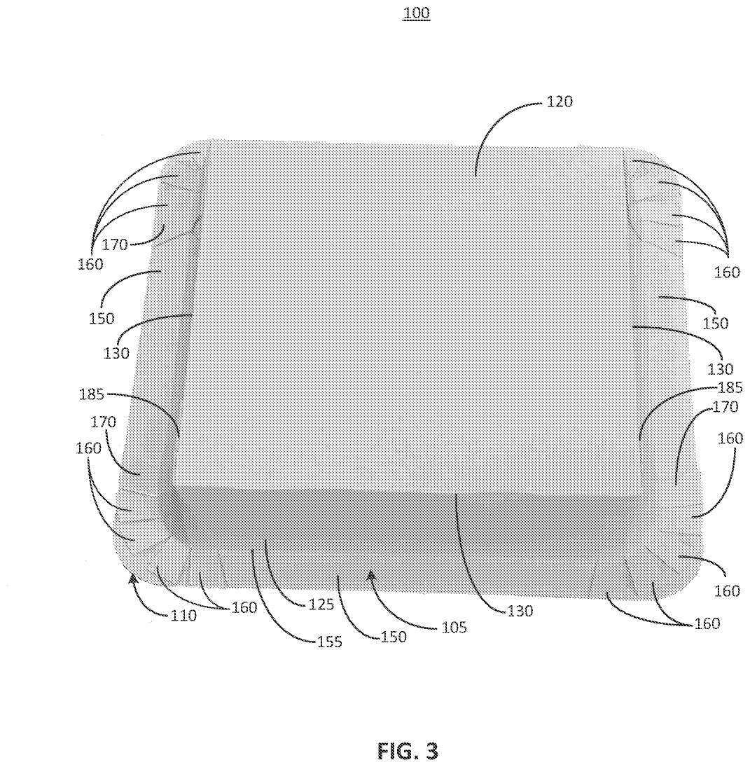

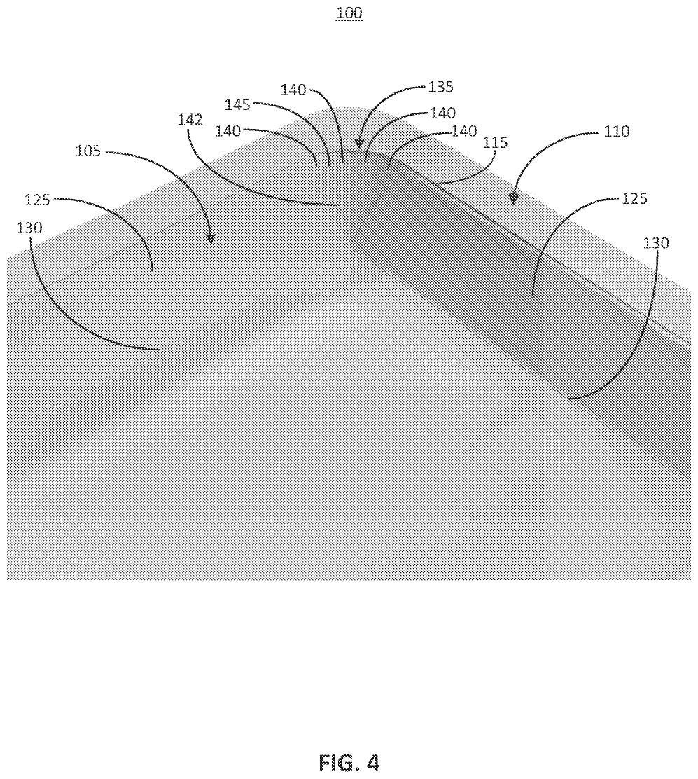

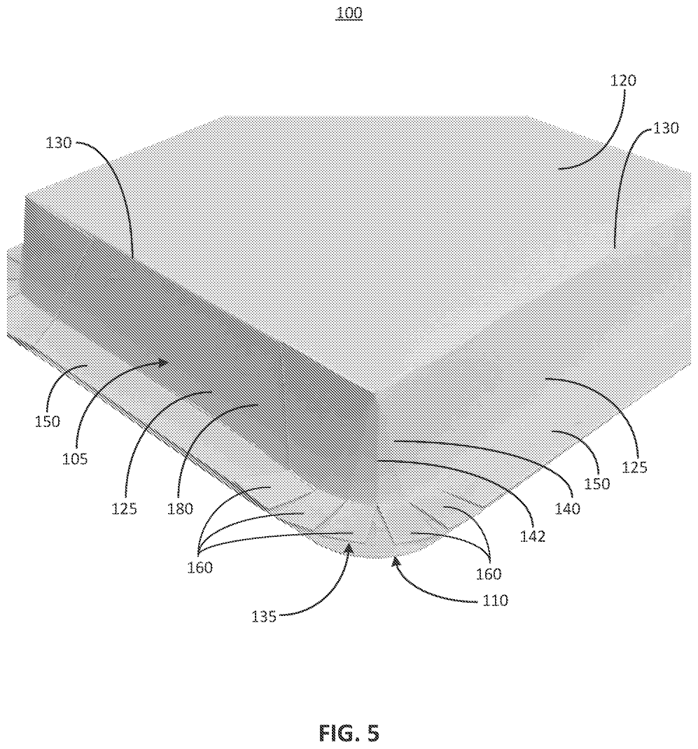

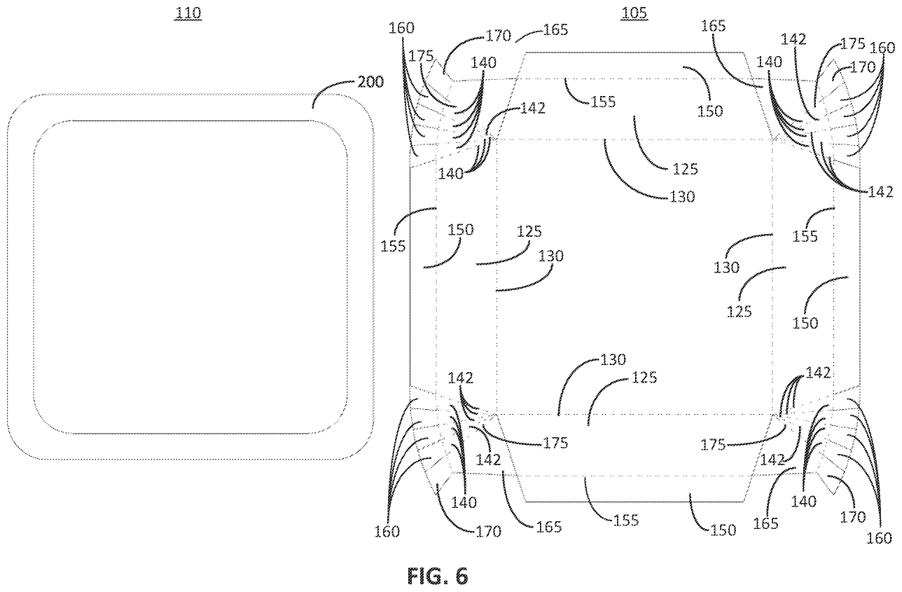

Referring now to FIGS. 1-6, a full top perspective view (FIG. 1), a top view (FIG. 2), a bottom view (FIG. 3), a partial top perspective view (FIG. 4), a partial bottom perspective view (FIG. 5), and an unassembled view (FIG. 6) of a food tray 100 are illustratively depicted, in accordance with various embodiments of the present disclosure.

The food tray 100 may include a base portion 105 and an edge cover portion 110. According to various embodiments, when the food tray 100 is assembled, the base portion 105 may be securely coupled to the edge cover portion 110. The base portion 105 may be securely coupled to the edge cover portion 110 via an adhesive 115 such as, e.g., glue, a cohesive material, a heat seal, an ultrasonic seal, and/or other suitable securing means. The adhesive 115 may be a layer over the support medium or blank, may be contained or integrated into the support medium or blank. The attachment can be implemented for example by way of the application of an action to the pertinent product area.

According to various embodiments, the base portion 105 is monolithic in design. The base portion 105 may include a planar bottom portion 120 including one or more side wall portions 125. The one or more side wall portions 125 may extend from the planar bottom portion 120 along a fold line 130 defined between the planar bottom portion 120 and the one or more side wall portions 125. Each of the one or more side wall portions 125 may be configured to fold along the fold line 130 (e.g., during assembly of the food tray 100). The angle formed between by adapted side wall portions 125 with the bottom portion 120 is preferably at an angle greater than 90 Degrees such as 108 Degrees as shown, preferably in the range of 100-120 degrees. The angle is adapted to provide descending slope that preferably creates a larger top opening leading to the bottom portion 120. The slope in conjunction with the corner portions 135 adapt the tray to provide a food container for prepared foods such that they can be removed or consumed from the tray.

According to various embodiments, between each of the one or more side wall portions 125 are one or more corner portions 135. According to various embodiments, one or more of the one or more corner portions 135 may have a generally rounded appearance from the perspective of a viewer.

Each of the corner portions 135 may include one or more triangular corner folds 140. The one or more triangular corner folds 140 may be configured to be folded over each other, along fold lines 142, resulting in the formation of the rounded visual appearance at corner portions 135 using gradual triangle portions. The corner folds 140 have the fold lines at the junction of adjacent corner folds that are adapted to gradually start at a starting side wall and end at an adjacent side wall to close the approximately right-angle relationship between the side walls using straight wall pieces (triangles) that are implemented without requiring a curve/rounded plan to achieve the turn. The corner folds can be continuous distanced structures that do not require assembly to create the right-angle connection. At each fold, there may be a bend or round shape at the fold. Thus, by way of s sequence of triangles and fold a generally rounded appearance is achieved. According to various embodiments, the one or more triangular corner folds may be secured to the side wall of the tray using an adhesive 145 such as, e.g., glue, a cohesive material, a heat seal, an ultrasonic seal, and/or other suitable securing means. The adhesive may be a layer over the support medium or blank, may be contained or integrated into the support medium or blank. The attachment can be implemented for example by way of the application of an action to the pertinent product area. To clarify, the triangular corner folds 140 can be part of part of a larger portion (e.g., portion 165) that extends over or behind the adjacent sidewall (e.g., 125) to secure the triangular corner folds.

With specific reference to FIGS. 5 & 6, each of the one or more side wall portions 125 may include one or more edge portions 150 extending from a corresponding side wall portion 125. Each edge portion 150 may be configured to be folded along a fold line 155 defined between the edge portion 150 and the side wall portion 125. The edge portions may be adapted to be parallel to the bottom surface of the tray (e.g., to form flat top or lip (or flange) that extends outward away from the interior of the tray). According to various embodiments, between each of the one or more edge portions 150 may be a plurality of cut extensions 160, extending from the corner portions 135, configured to fold along fold line 155. According to various embodiments, each of the plurality of cut extensions 160 may be configured to correspond to a triangular corner fold 140 of the rounded corner portions 135.

According to various embodiments, the base portion 105 of the food tray 100 may include an outer flap portion 165 (FIG. 6) configured to extend from a lateral-most fold line 175. The outer flap portion 165 may include an outer flap extension portion 170 extending from the outer flap portion 165. The outer flap portion 165 may be configured to be folded over, and engaged along, an outer surface 180 of an adjacent side wall portion 125. According to various embodiments, each outer flap portion 165 may be securely coupled to a side wall portion 125 of the one or more side wall portions 125, aiding in maintaining a shape of the base portion 105 in an assembled position. The outer flap portion 165 may be secured to the side wall portion 125 via an adhesive 185 such as, e.g., glue, a cohesive material, a heat seal, an ultrasonic seal, and/or other suitable securing means. The adhesive 185 may be a layer over the support medium or blank, may be contained or integrated into the support medium or blank. The attachment can be implemented for example by way of the application of an action to the pertinent product area.

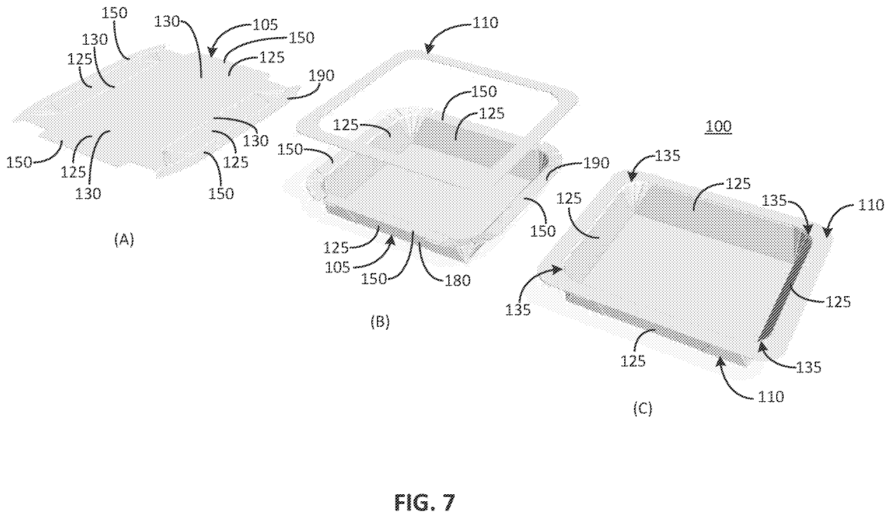

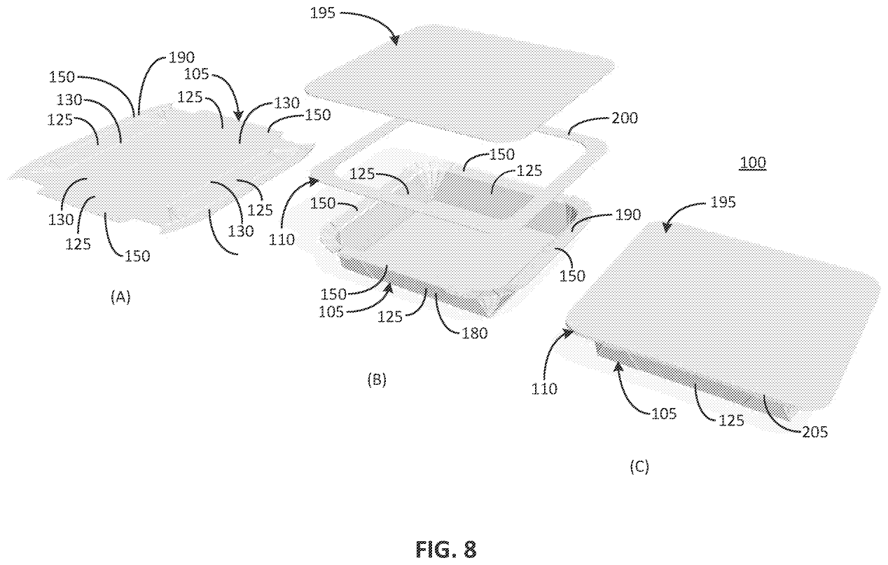

According to various embodiments, the edge cover portion 110 may be configured to be securely coupled to a top surface 190 (see e.g., FIG. 7) of the base portion 105 (e.g., of the one or more edge portions 150 and/or the one or more outer flap extension portions 170) along approximately an outer perimeter of the base portion 105. The edge cover portion 110 may be securely coupled to the top surface 190 of the one or more edge portions 150 and/or the one or more outer flap extension portions 170 via an adhesive 115 such as, e.g., an adhesive material (e.g., glue), a cohesive material, a heat seal, an ultrasonic seal, and/or other suitable securing means. The adhesive 115 may be a layer over the support medium or blank, may be contained or integrated into the support medium or blank. The attachment can be implemented for example by way of the application of an action to the pertinent product area.

With specific reference to FIG. 6, the food tray 100 is depicted in an unassembled configuration, in accordance with various embodiments of the present disclosure. The food tray 100, as depicted in FIG. 6, may include the base portion 105 (die-cut blank or blank) and the edge cover portion 110.

According to various embodiments, the base portion 105 is or includes a planar die cut. As shown in FIG. 6, the base portion 105 is represented with a series of dotted lines, with each representing fold lines (e.g., 130, 140, 155, 175) along which the portions of the base portion may be folded (the base portion is adapted to have the fold lines), and a series of solid lines, representing portions of the base portion 105 which are cut.

According to various embodiments, one or more portions of the base portion 105 may include one or more portions that are identified to be “cut,” which may represent perforations and/or other suitable configurations for tearing and/or otherwise separating a portion of the base portion 105 from another portion of the base portion 105, along a line that makes the separation of the adjacent portions of the base portion 105 easier to tear apart.

For example, during assembly of the food tray 100, the process(es) of bending and/or other operations for performing assembly of the food tray 100 may cause such adjacent pieces to pull in directions that, due to the perforation, allow the adjacent portions to separate (tear in a guided manner due to the perforation). For example, when tabs 170 are adapted to be folded and in position for a final assembly, the change in the direction of the triangular fold in combination with the folding of the tab will generate force that will automatically separate the tabs along the perforations or tear lines of the tabs without requiring a separate action to create the breaks.

According to various embodiments, the media, or blank, for the food tray 100 may preferably be a solid board that may be adapted to be die cut in order to form an unassembled food tray 100, as illustratively shown in, e.g., FIG. 6. The food tray 100 is preferably made of a material that is configured to be adapted into the form of the tray 100 using only force applied to the blank to adapt the blank to have the described folds that together shape the tray. An operation such as heat and pressure can be applied to bind or attach portions of the food tray 100 together such as to attach portions 165 to side wall 125 or to attach portion 200 to portion 190 when the adhesive requires heat action.

According to various embodiments, the food tray 100, in an assembled configuration (e.g., as shown in FIG. 1), may include one or more die cut tray components (e.g., base portion 105 and edge cover portion 110) that may be configured to be sealed together in order to form rigid food tray 100. According to various embodiments, the food tray 100 may be configured, as described, to meet one or more size and/or volume requirements for various food trays, may be configured to not leak during expected use and/or during preparation, may be configured to not delaminate during expected use and/or during preparation, may be configured to withstand edge wicking and/or staining at exposed cut edges, may be configured to fit in a carrier plate, and/or may be configured to accept one or more lidding films. For example, the attachment of portion 165 to sidewall 125 is adapted to from a seal at the corner that is sufficient to prevent food (including liquids) from leaking at the corner.

According to various embodiments, the food tray 100 is configured to store food and the base portion 105, edge cover portion 110, and/or one or more of the securing means 115, 145, 185 are suitable for coming into contact with food. The base portion 105 and/or the edge cover portion 110 may include a base substrate. According to various embodiments, the base substrate is adapted to be folded to form the food tray 100 and is recyclable, compostable, and/or biodegradable. The base substrate may comprise a cellulose base substrate (e.g., paper) and/or other suitable recyclable base substrate including natural fiber (e.g., bamboo). According to various embodiments, the base portion 105 and/or the edge cover portion 110 may include a paper board base substrate. According to various embodiments, the base substrate may be a continuous piece of material and/or comprised of a single piece of material.

According to various embodiments, the base substrate, as a result of a surface treatment and/or through the structure of one or more layers of the base substrate, may be configured to prevent the base substrate from absorbing one or more liquids (e.g., water, oil, etc.), may be configured to aid in preventing the food tray 100 from leaking such substances (e.g., during use and/or during heating of the food tray 100), and/or may be configured to enable the base substrate to have other suitable properties such as, e.g., the ability to withstand hot and/or cold temperatures. According to various embodiments, some or all of the materials included in the food tray 100 are recyclable, biodegradable, and/or compostable. The paper board base substrate may comprise a coating and/or non-plastic laminate coupled to at least one surface of the base portion 105 and/or the edge cover portion 110. According to various embodiments, the base substrate is comprised nearly or entirely of paper and/or is substantially without plastic. According to various embodiments, the base substrate may comprise printed and/or otherwise applied material over a base material.

According to various embodiments, the food tray 100 includes one or more materials configured for use in one or more food and/or beverage heating devices (e.g., ovens, microwaves, etc.) and/or in one or more food and/or beverage cooling devices (e.g., refrigerators, freezers, etc.). According to various embodiments, the base portion 105 and/or the edge cover portion 110 may include solid bleached sulfate paperboard (SBS). It is noted, however, that the base portion 105 and/or the edge cover portion 110 may include one or more other suitable materials, while maintaining the spirit and functionality of the present disclosure. It is contemplated that other types of board or medium are used such as coated unbleached kraft, tan bending chip, clay coated newsback, clay coated kraftback, and solid unbleached sulphate. Preferably, in the production process, an action (e.g., stamping) is applied to a paperboard (or other single sheet support medium) that produces the shape, outline, and base features for example as shown in FIG. 6. This is sometimes called a flat die line structure. This resulting structure can be a single piece of paperboard having cuts, fold seams, and other features as described herein. It is contiguous as shown.

Using one or more of the materials described above for the manufacture of the base portion 105 and/or the edge cover portion 110, the food tray 100 provides a wide-scale commercial solution to problems in the food tray industry that can be provided that meets commercial sustainability requirements (e.g., avoiding the use of plastics with respect to food preparation and storage packaging) while simultaneously providing food preparation and storage packaging which includes rounded corner portions 135 established, e.g., by a series of adjacent triangular corner folds 140. The present configuration of the base portion 105 and the edge cover portion 110 of the food tray 100 provides a functionally rounded shape while also enabling and providing a quick and efficient assembly process (e.g., involving the combination of the cuts in the die cut base portion 105 and the heat sealable aspect of the base portion 105 by way of a surface treatment, providing a food tray conducive for use in disposable consumer food and beverage implementations including frozen or refrigerated prepared foods for consumers and can include other applications). According to various embodiments, the base portion 105, when assembled, forms a receptacle 107 configured for receiving and/or storing one or more items (e.g., food, beverages, utensils, etc.). The material or substrate that forms the food tray 100, e.g., 105, is preferably material that is adapted to withstand (in its normal state of use) being heated in a conventional oven using temperatures up to about 220 Celsius and to withstand (in its normal state of use) being stored in a consumer refrigerator or freezer for an extended period of time (days or months) without significant damages such that the function of supporting and containing the food in the container is not lost. The material or substrate that forms the food tray 100, e.g., 105, is preferably material that is adapted to be opened (from the top) after heating or thawing and provides the assembled tray as a dish or bowl for eating the food without leaking or loss of rigidity such that such functionality is not lost (e.g., the food is not spilled or leaked).

Various embodiments are contemplated for the food tray 100 such as the base portion 105 and/or the edge cover portion 110 including plastic and/or being free of plastic (e.g., such that it would be recyclable, compostable, and/or biodegradable). According to various embodiments, the inclusion of a small trace of plastic in the could exist in the base portion 105 and/or the edge cover portion 110. To clarify, an objective (which is being met) is to provide a paper based biodegradable product that avoids including plastics in the construction and avoid reliance on the functional benefits of plastic material in the construction and characteristics of the tray. If desired, in some embodiments, the tray or portions thereof can be made of plastic or other materials if a particular application is suitable. In other words, in some applications, the structure of the tray may have advantages that are not dependent on the tray being recyclable compostable, or biodegradable. Preferably, the substrate or medium is one that is configured to being folded into assembly and adjoining surfaces are attached by the combination of heat and pressure and is not of the type of conventional tray production that molds the tray structure using heath such as thermoforming or molding.

In some embodiments, attaching the separate rim piece (to the left on FIG. 6) to the top of the structure can provide structural strength and can provide an enhanced “rounded” appearance given that the corner is cut to be rounded by have a continuous curve while the rounded corner underneath is made of short straight lines.

Referring now to FIG. 7, a flow diagram depicting the food tray 100 in various stages of production is illustratively depicted, in accordance with various embodiments of the present disclosure.

Section (A) of FIG. 7 illustratively depicts the base portion 105 of the food tray 100 in an unexpanded configuration. Section (B) of FIG. 7 illustratively depicts the base portion 105 in a folded/assembled configuration with the edge cover portion 110 positioned above the base portion. According to various embodiments, the one or more side wall portions 125 are folded, along fold lines 130, over the planar bottom portion 120, while the one or more triangular corner folds 140 (e.g., FIG. 6) are folded over each other. According to various embodiments, the one or more edge portions 150 of the one or more side wall portions 125, and the one or more cut extension portions 160, are folded, along fold lines 155. The one or more cut extension portions 160 may be configured to fold separately from the one or more edge portions 150 of the one or more side wall portions 125.

According to various embodiments, the outer flap portion 165 may then be configured to be folded, along lateral-most fold line 175, and positioned along the outer surface 180 of the one or more side wall portions 125 (e.g., along an outer surface 180 of each of the one or more side wall portions 125). According to various embodiments, the outer flap portions 165 are sealed, via securing means 185, to the outer surface 180 of the one or more side wall portions 125.

According to various embodiments, once the base portion 105 is assembled, the edge cover portion 110 is secured to a top surface 190 of the base portion 105 (e.g., a top surface of the one or more edge portions 150 and/or a top surface of the plurality of cut extensions 160), via the one or more adhesive 115, producing, e.g., the assembled food tray 100 shown in section (C) of FIG. 7. The edge cover portion 110 may be configured to provide both structural strength to the food tray 100 and/or provide an enhanced rounded appearance of the rounded corners of the food tray 100, since the edge cover portion 110 may cover the plurality of cut extensions 160.

According to various embodiments, the food tray 100 may include a lid portion 195 (see FIG. 8) configured to be secured to a top surface 200 of the edge cover portion 110 via one or more adhesive 205 such as, e.g., glue, a cohesive material, a heat seal, an ultrasonic seal, and/or other suitable securing means. As shown in FIG. 8, in section (A), the base portion 105 of the food tray 100 is illustratively depicted in an unexpanded configuration, in section (B), the base portion 105 is illustratively depicted in a folded/assembled configuration with the edge cover portion 110 positioned above the base portion and the lid portion 195 positioned above the edge cover portion 110, and, in section (C), the fully assembled food tray 100 is illustratively depicted with the edge cover portion 110 secured to top surface 190 of the base portion 105 and the lid portion 195 secured to top surface 200 of the edge cover portion 110. According to various embodiments, the lid portion 195 (or portions thereof) may be removably secured to the top surface 200 of the edge cover portion 110. In some embodiments, the lid portion 195 is removable from and/or resealable to the top surface 200 of the edge cover portion 110, enabling the food tray 100 to be opened and/or closed. If desired, a tray containing food as consumer product can be configured to be without portion 200 and/or 195. Meaning variations are contemplated. In some embodiments, if desired, a film such as a plastic film is positioned over the top of the tray such as across 200.

It is noted that, according to various embodiments, the order to apply the attachment material 115, 145, and/or 185, and/or 205 may be in various order and/or each securing means may, according to various embodiments, not be implemented/used in the assembly and formation of the food tray 100.

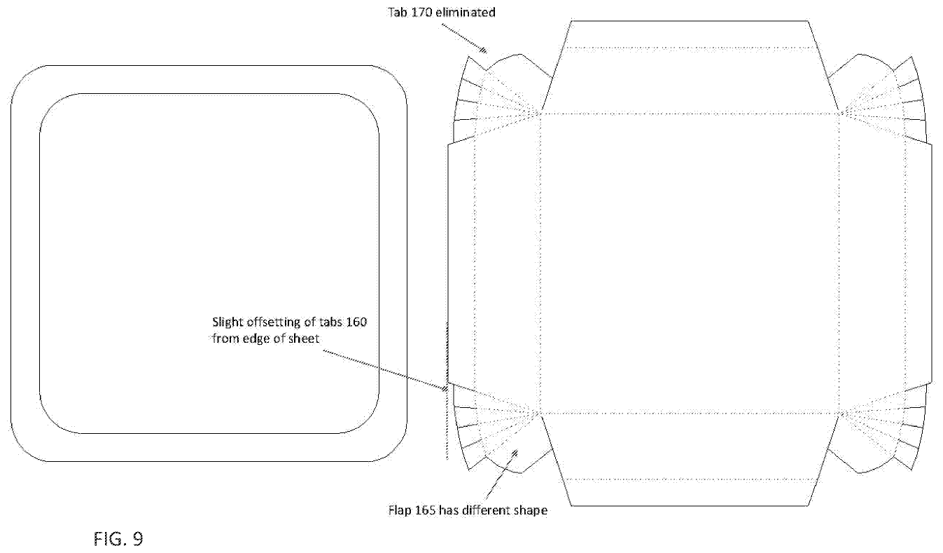

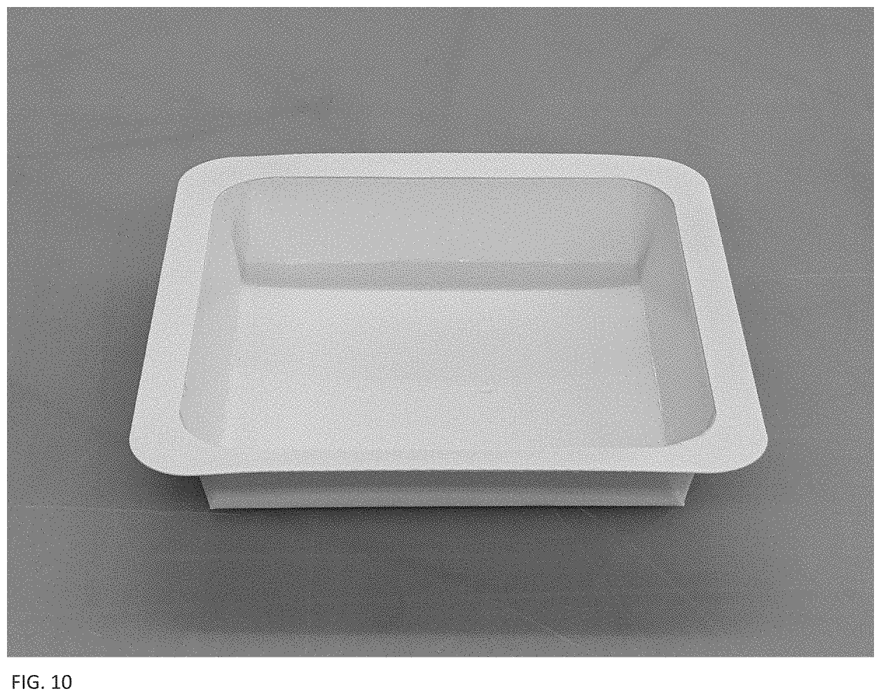

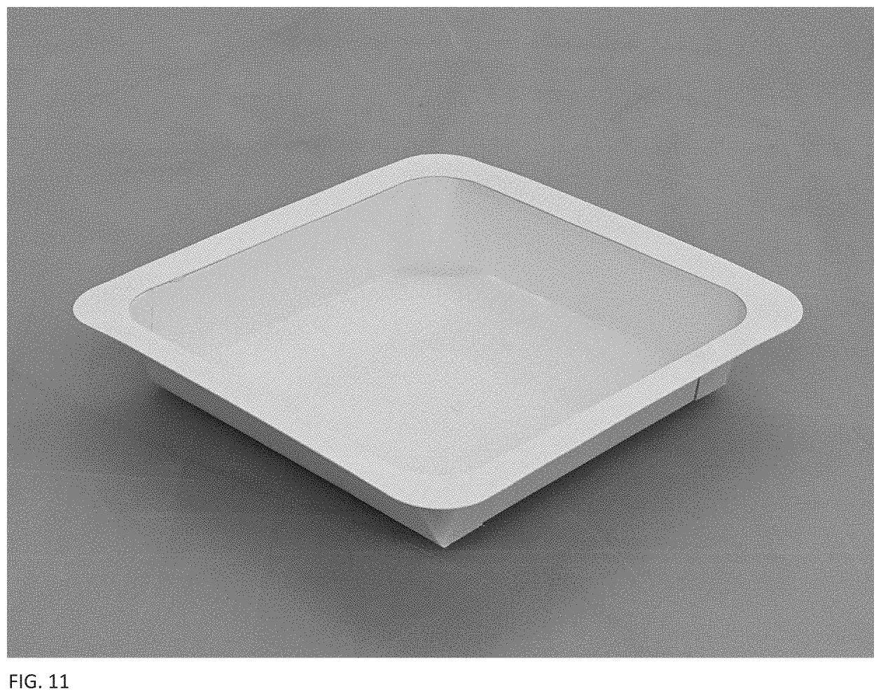

FIG. 9 (and FIGS. 10-13) illustrates an embodiment of the structure of the food tray (assembled and unassembled) in accordance with some embodiments of the present invention. FIG. 9 shows the blank or flat structure of the tray (after being pressed or stamped into formation) before assembly. As shown, tabs 160 are structured to be fewer such as four tabs and the flap 165 is a shorter and more uniform shape (compared to prior figures). For example, this reduces the bonding surface area. Any other differences are also visually evident. This provides fewer folds at the corner to provide the curve appearance. FIG. 14 shows the stacking or nesting of multiple trays. As mentioned earlier, in the figure, dashed lines illustrate fold lines defined on the board and solid lines are cuts which can be a cut that separates to adjacent sides of the cut material or can be a line of perforation (e.g., series of cuts in a line) that in the mechanical assembly of the folds to produce the arrangement of the tray are separated to form the cuts.

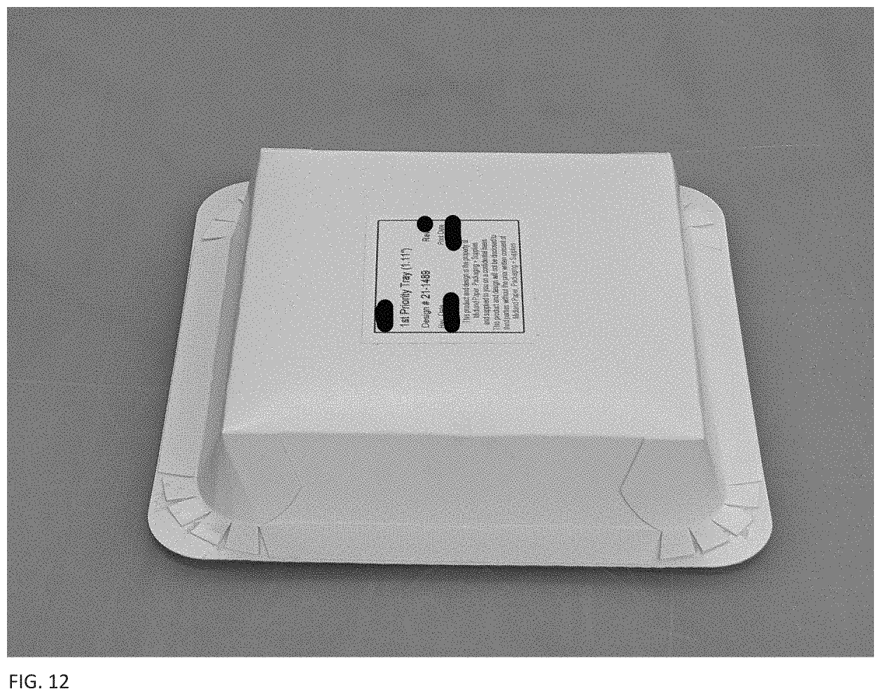

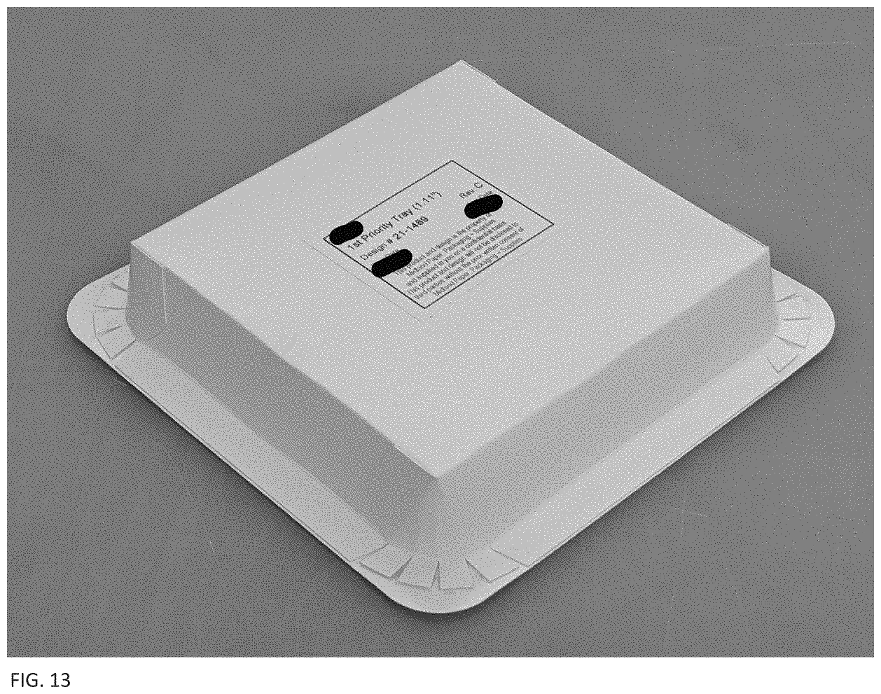

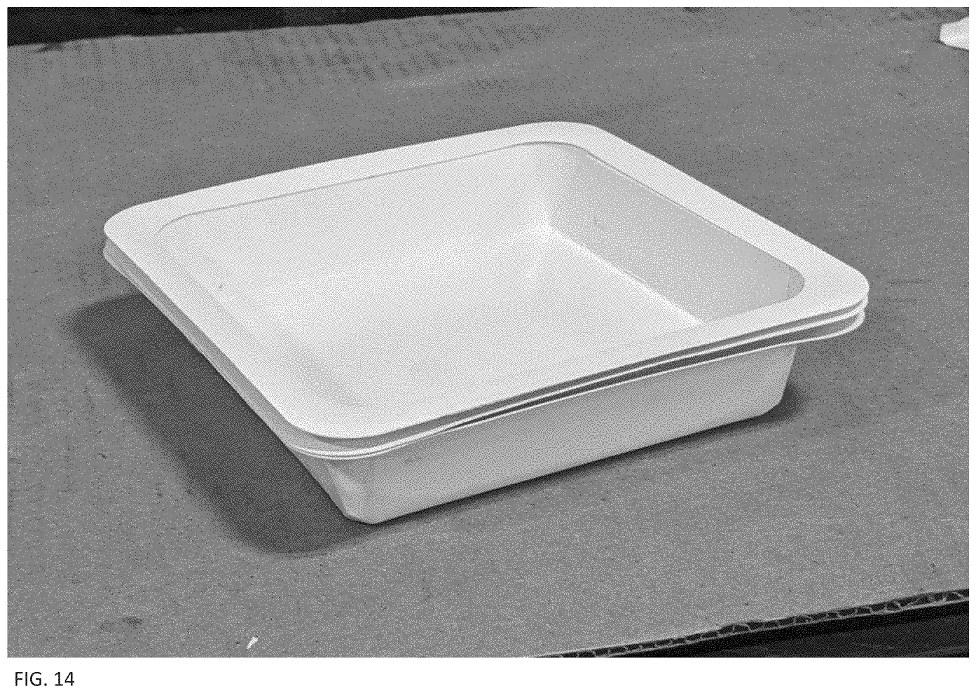

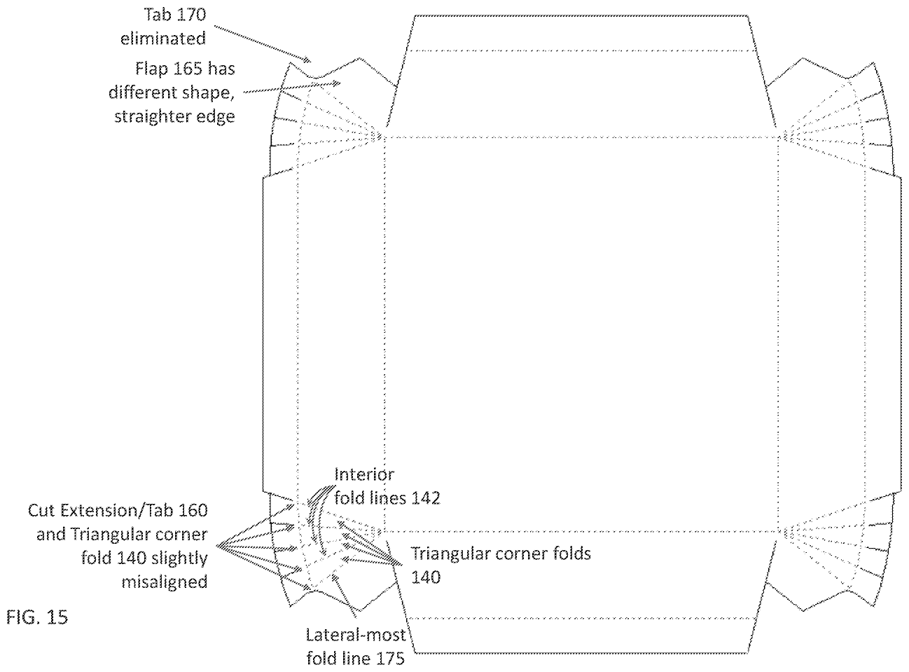

FIG. 15 illustrates an embodiment of the structure of the food tray in accordance with some embodiments of the present invention. FIG. 15 shows the flat structure of the tray (after being pressed or stamped into formation) before the assembly. As shown, tabs 160 are structured to be four tabs and the flap 165 is shorter. Flap 165 of FIG. 15 has a smaller surface area and involves three cut lines where the outer sides (cuts) intersect at a point and form an angle that is greater than 90 Degrees such as 120 Degrees. The flap 165 is adjacent to the outermost tab as shown and there is a curved transition from the edge of the tab to the edge line that shapes the outside of the tab adjacent to the tab.

Additionally, tabs 160 are offset from the outside edge of edge portion 150 (in prior figures, the outside edge of edge portion 150 continues directly into the outside edge of tabs 160 as shown except for the illustrated cuts). In FIG. 15, the outside edge of the tabs 160 is a line that is a continuous line in appearance (except for cuts) (as a result of the die cut or press) and aligned to provide a continuous line that starts a position that is generally parallel with the outside edge of edge portion 150 and is distanced from the outside edge of edge portion 150. As shown, there is a diagonal line that is at the same angle as the cut at the side of the tab adjacent to edge portion 150. An expanded view is provided in FIG. 24.

With reference to FIG. 24, as shown, the outer edge of edge portion 150 is spaced from the outer edge of adjacent tab 160. In this arrangement, when the tabs are folded during assembly and the edge cover is positioned over the tabs 160, the outer edges of tabs 160 are positioned to be at or spaced away from the outer edge of the edge cover (they would not be visually sticking out from a top view). There are other structural details that are highlighted in FIG. 24. Offset2 shows that there is an offset of spacing (gap) between the top fold line and the side edge cut of tab(s) 160. As shown, in some embodiments, the tray is adapted to have a structure (die cut configuration) that includes a small gap (of material) between the end of a cut and a corner point (vertex) of a fold such as point 2402 or at fold line of edge portion 150. The small gap or offset helps to avoid potential pinhole leaks at the corner by using a small amount of the material. The gaps or offset of cuts from vertexes (corner point) is particularly beneficial in areas that are likely going to be supporting or in direct contact with the contents of the tray. For clarification offset1 is implemented for a different objective than offset2, offset3 and offset4 which the latter provide leak resistance by way of the “gap.”

Offset3 is adapted to be positioned at the junction area of the outer most tab 160 and the flap 165. As can be observed the outside most fold line of tab 160 is a straight line that is directly aligned with the outer side edge of the tab 160 except that the outer side edge of tab 160 has a transition by way of a gradual curve that transitions from the line of the outer side edge of tab 160 to the edge of flap 165. As can be observed, there is an area that is created by way of the transition that is adjacent to the intersection of the tab 160's fold lines at the corner. As opposed to a straight edge connections to a point at the intersection of the top fold line, lateral fold line, flap and outside edge of the tab, there is a spaced apart area or transition area providing for some additional surface area at the general area of that junction. When the tray is assembled by a machine, the additional surface when folded as shown in the figures provides for a better seal or enclosure at that junction in the structure and as such provides better protection or resistance to leaks (relative to a structure that intersect at a point). The point intersection of outside edge of tab 160 and flap 165 is revised to a rounded curve that transitions from edge to the other.

Offset4 involves a structural spacing that can be configured when the substrate is formed. First, the cut at the outer edge of 150 is formed to stop short of reaching the corner where the fold lines for the corner and the corner for the bottom and side walls of the tray intersect 2402. This spacing of the cut from the fold line (or point) adapts the corner to provide leak protection or resistance when the tray is mechanically folded. There would be at least some “extra” material that when folded would provide such benefits as planned. When fold, due to the gap created by offset 4, the pertinent material would “bunch” at the corner to form a small tucked fold (or multiple folds or material bunching) very close to the bottom corner (there may be a small amount of material that will bulge out such as from the bottom). The adaption of the structure is such that material at corner would include a fold or gathering that would wrap around at or slightly above the corner or vertex (tray bottom corner). One, some, or all of such features can be included in the structure of the tray. The amount of misalignment or spacing is such that at one extreme it does not become an obstacle to the successful fold and attachment of surfaces or does not result in structurally deform the intended straight walls of the ray. A misalignment created by planned shift of an angle of an edge relative to a fold corner so as to not have the line of the edge intersect with the fold corner (meaning have a small angle phase shift away from the line of intersection with the corner) is illustratively described. For example, offset3 involves having the flap 165 having an edge line that does not connect or intersect with the corner of intersecting tab fold lines (there is a spacing). These features can among other things provide additional leak protection or leak resistance and contemplated in combination will illustrative trays disclosed herein.

FIG. 24 is not drawn to scale but for illustration in constructed trays: offset1 is 3/32 inch, offset2 is 0.065 inch, offset3 is 0.034 inch, and offset4 ⅛ inch, offset.

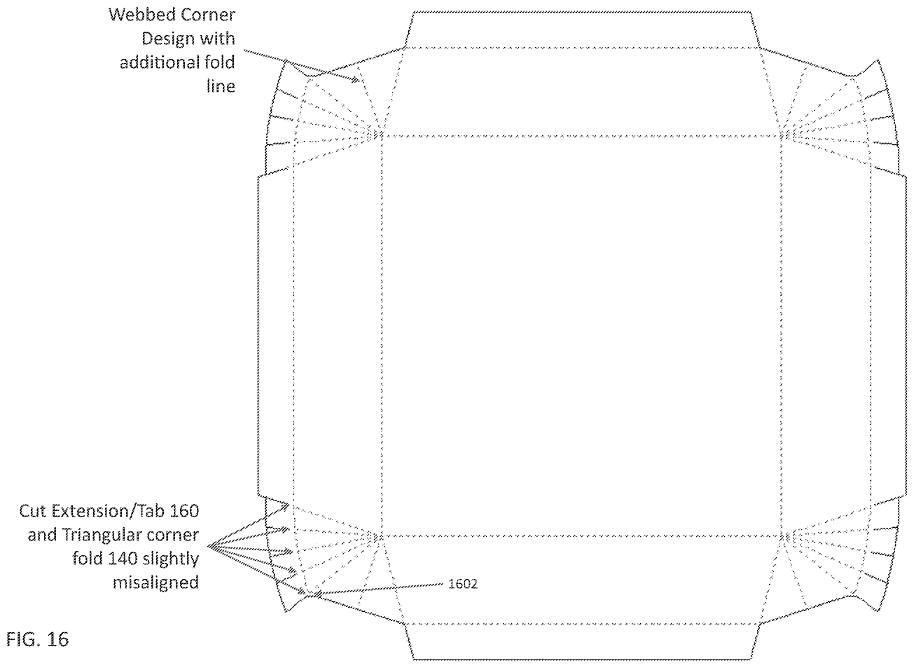

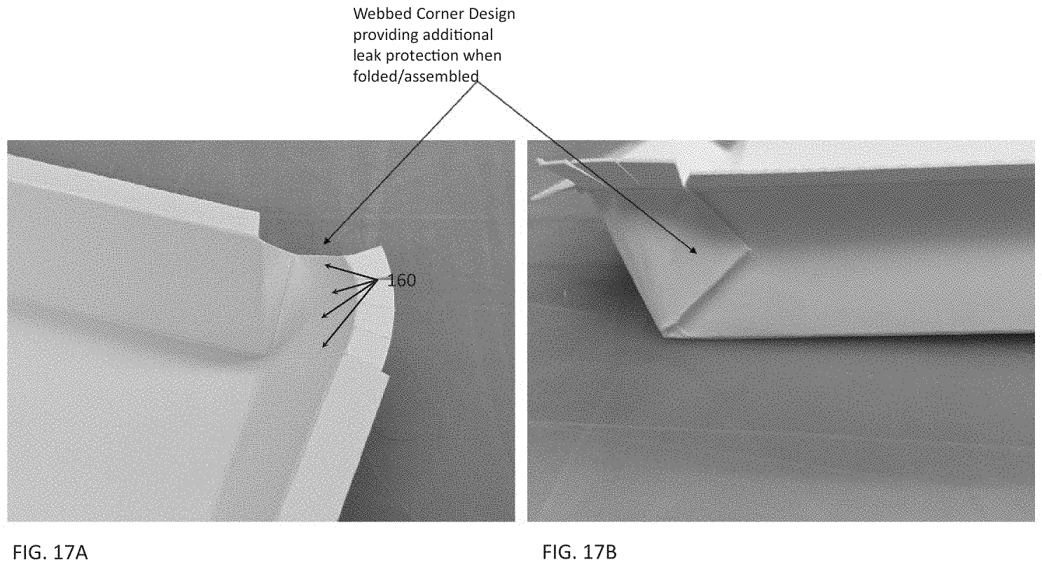

FIG. 16 illustrates an embodiment of the structure of the food tray in accordance with some embodiments of the present invention. FIG. 16 shows the flat structure of the tray (after being pressed or stamped into formation) before the assembly. As shown, the tray is structured to have four tabs. Additionally, a webbed corner (as opposed to flap that is loose at one end) is extended to the adjacent edge portion 150 and contains an additional fold line positioned in the center of that portion. The triangle, as shown, are about the same size. The webbed corner is configured to be folded over when assembled. This webbed corner embodiment provides the curve corner appearance as well as additional leak protection when the webbed corner is folded “out” and wrapped around and the food tray is assembled as seen in FIGS. 17A and 17B. As in the other figures of blanks, solid lines correspond to cuts (or perforations that create cuts) and dashed lines are fold lines. As shown, there board at the corner's connects the edge portion 150 to the outermost tab 160 via the continuous material of the board. There is a fold line for example as opposed to a cut at the edge of edge portion. A fold line is positioned at about the center of that area that allows the material to be folded and wrapped to be positioned flat next to a surface of the adjacent sidewall. One side of the folded triangle or generally speaking flap created by a fold abuts the surface of the sidewall so that through heat and pressure it attaches to the sidewall. An offset feature is included in the illustrated tray at about the area in which the edge of the outermost tab 160 (at a corner) connects with the top edge of the web potion or web corner. This corresponds to offset3 in FIG. 24. The web corner as shown is in the shape of a triangle, but other folding arrangement of that corner area are contemplated.

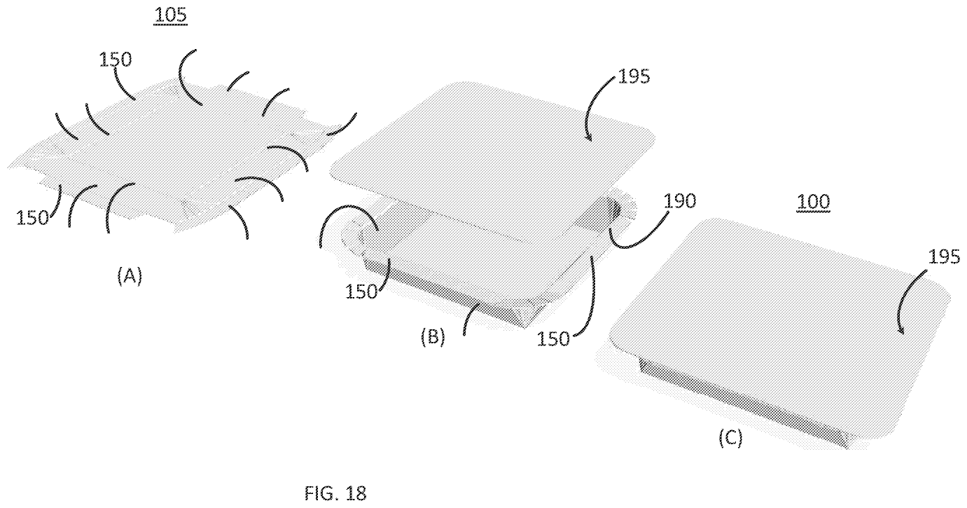

According to various embodiments, the food tray 100 may include a lid portion 195 configured to be secured directly onto a top 190 surface of the edge cover portion 150 via one or more adhesives such as, e.g., glue, a cohesive material, a heat seal, an ultrasonic seal, and/or other suitable securing means. As shown in FIG. 18, in section (A), the base portion 105 of the food tray is illustratively depicted in an unexpanded configuration, in section (B), the base portion 105 is illustratively depicted in a folded/assembled configuration with the lid portion 195 positioned directly above the top 190 surface of the edge cover portion 150, and, in section (C), the fully assembled food tray 100 is illustratively depicted with lid portion 195 secured to top surface 190 of the edge cover portion 150. According to various embodiments, the lid portion 195 may be made of paperboard. In some embodiments, the lid portion 195 may comprise a perforated portion 295 with or without the lid notch 300 to provide a tear-off portion to remove the section of the lid portion 195 to access the contents of the food tray 100. In some embodiments, the lid portion 195 may be configured to accept one or more lidding films to prevent the content (including liquids) from leaking from the top (e.g., when a packed tray is positioned sideways) and to visualize the content inside the food tray when the perforated portion 295 is torn off .

Flap portion 165 is adapted to have dimensions based on the overall tray structure. The bottom edge (cut edge) of flap portion 165 is cut at an angle that when folded the edge does not exceed the bottom of the tray or is aligned with that bottom of the tray. The top edge of the flap potion 165 is cut to be an angle that avoids (slides below) the tabs when being bolded.

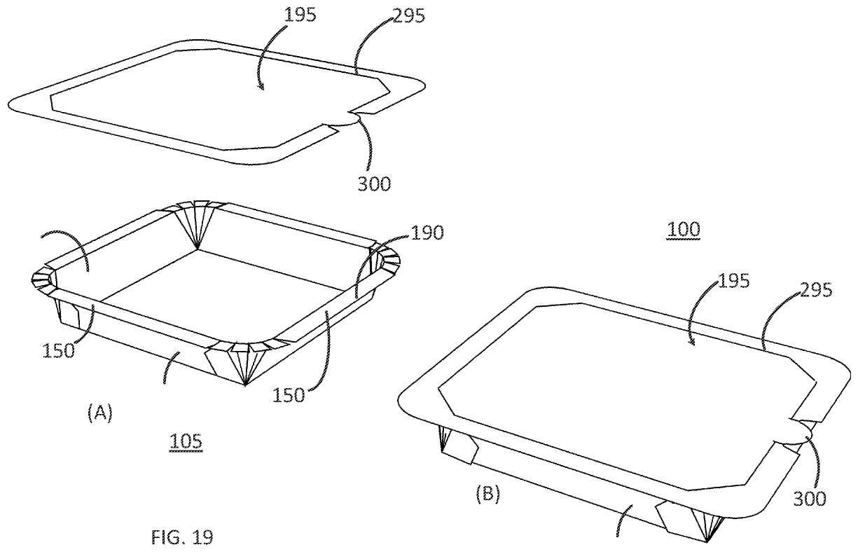

In some embodiments, as shown in FIG. 19, in section (A), the lid portion 195, perforated portion 295 with lid notch 300 to engage the lid opening along the perforated section, and the base portion 105 are illustratively depicted separately, and in section (B), the fully assembled food tray 100 with the attached lid portion 195, perforated portion 295 with lid notch 300 are illustratively depicted.

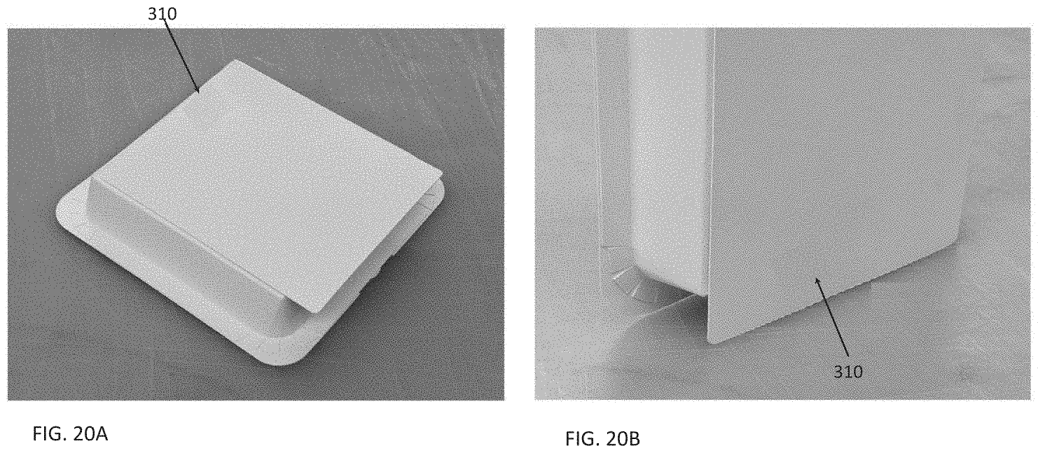

According to various embodiments, the food tray 100 may provide vertical stand options for the food tray to stand upright on the shelves, or in freezer/refrigerated sections of the store. In some embodiments, a vertical stand option may comprise a card piece 310 attached to the bottom of the base portion 105 and overhanging from at least one bottom edge in line with the edge cover 150 to provide a vertical stand option as shown in FIGS. 20A and 20B.

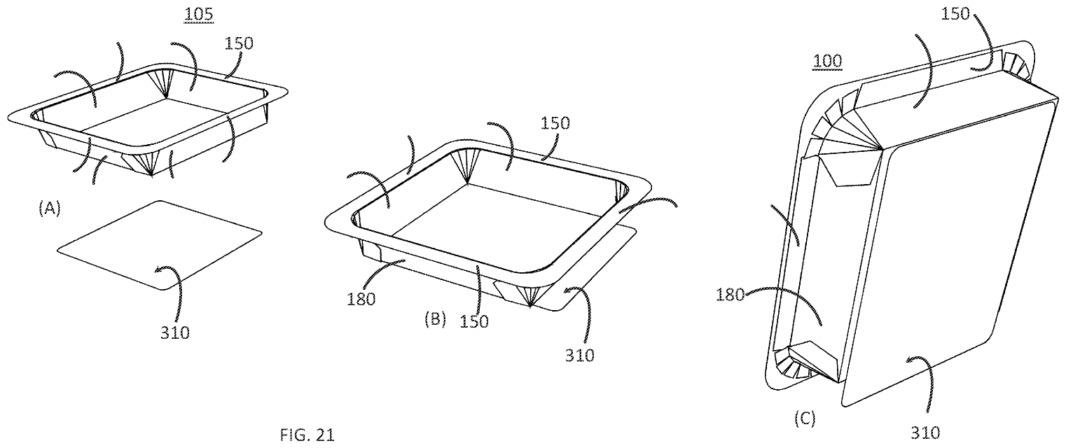

As shown in FIG. 21, in section (A), the card piece 310 and the base portion 105 are illustratively depicted separately, in section (B), the attached card piece 310 and the base portion 105 are illustratively depicted in an assembled configuration with the card piece 310 overhanging from the bottom of the base portion 105 in line with at least one of the edge portion 150, and in section (C), the fully assembled, upright food tray 100 is illustratively depicted with the edge portion 150 and the overhanging card piece 310 acting as a vertical stand as shown in FIG. 20B.

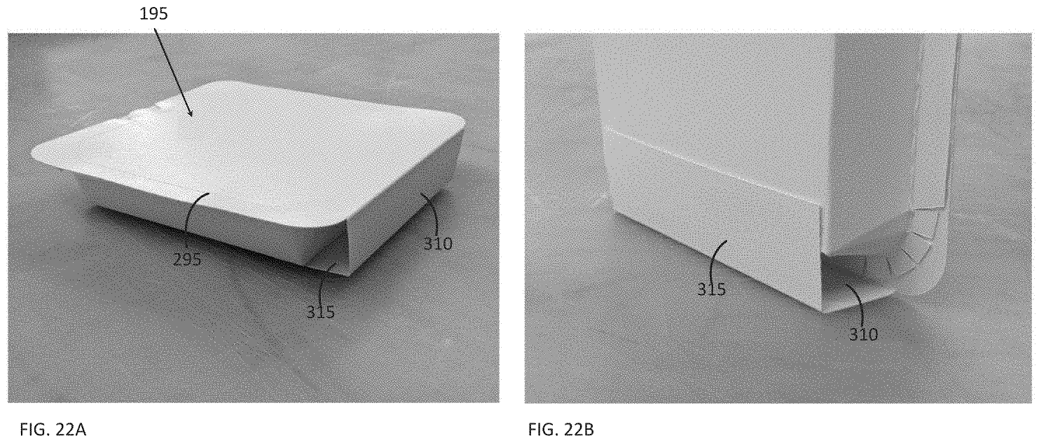

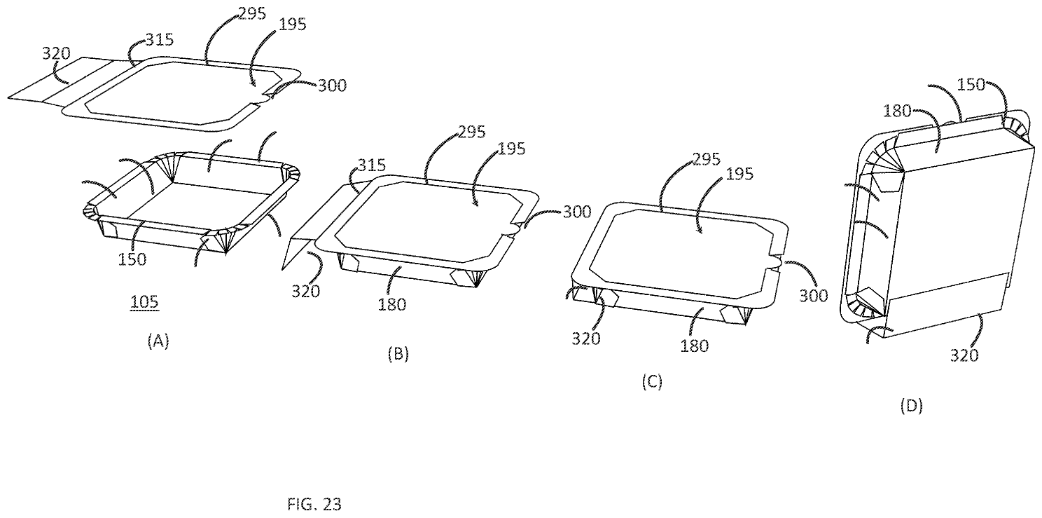

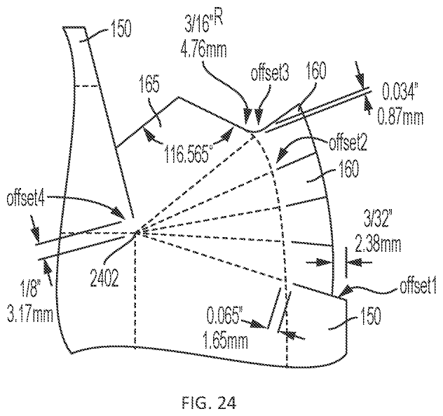

According to various embodiments, a vertical stand option may be a stand-integrated lid portion. In some embodiments, the vertical stand option may be a lid piece 195 modified with additional lid extensions 315 and 320 folded/wrapped around to the bottom of the food tray base portion 105 as seen in FIGS. 22A and 22B. As shown in FIG. 23, in section (A) lid piece 195 modified with folding lid extensions 315 and 320, and the base portion 105 are illustratively depicted separately, in section (B), the attached lid piece 195 and the food tray base are illustratively depicted in a partially assembled configuration with the lid extensions 315 and 320 overhanging from one edge portion 150, in section (C), the overhanging lid extensions 315 and 320 wrapped around to the bottom of the food tray base are illustratively depicted, and in section (D), the fully assembled, upright food tray 100 is illustratively depicted with the lid extension 320 attached to the bottom of the base portion 105 providing structural support for the lid extension 315 as a vertical stand as shown in FIG. 22B.

In some embodiments, the stand-integrated lid may comprise a perforated portion 295 with or without the notch 300. According to various embodiments, the strand-integrated lid may further comprise a edge cover portion 110 modified with lid extensions 315 and 320 configured to accept one or more lidding films to prevent the content (including liquids) from leaking at the corners when positioned vertically and to visualize the content inside the food tray. In some embodiments, the lid portion 195 may be positioned above the stand-integrated edge cover portion 110 modified with lid extensions 315 and 350.

Examples of blank or substrate material can include products offered by APP (Asia Pulp and Paper), Delipac (www.delipac.com), WestRock, Stora Enso and Selzier Papier Gmbh such as the APP Foopak (www.foopak.com), Delipac Oven (www.delipac.com/delipac-oven), WestRock TruSery (https://www.westrock.com/products/paperboard/truserv-compostable-cupstock), Stora Enso Cupforma Natura Aqua+(https://www.storaenso.com/en/newsroom/news/2020/2/stora-enso-introduces-new-barrier-boards-to-replace-plastic-in-food-packaging), and Selzier Papier's Lipopack (www.salzer.at/en/papier/produkte/verpackungspapier/). Other examples can be found in patents or patent applications directed to paper food tray substrates or paperboards that are recyclable, compostable, and/or biodegradable. Barriertec (www.barrierpackaging.com) is a brand that applies a process to paperboard to adapt the structure to be suitable for the present applications for food and can be recyclable, biodegradable, and food approved (per the website). Delipac offers paperboard that has certifications that extend to include 100% biodegradable (land/sea), 100% compostable (home/industrial), 100% recyclable in any waste stream. The thickness of the material from which the tray is made for example be 250 to 500 microns (+/−10%). The material or substrate can be certified with respect to various requirements such as having all, some, or one of the following certifications, EN13432 bio certified, EN13430 recyclability certified, TUV OK Compost Home 2 Edition D bio certified, ISEGA EN1935/2004//FDA cfr21 food certified, EN 1186-4-5-13-15 ovenable +microwave certified, Freezer / Chiller compliant (Campden BRI), PFAS+PFOA free - *EN/TS 15968 certified, REACH 1907/2006/33 ECHA 2008/98 (SVHC) certified, and REACH 1907/2006/3 EUSUP 2019/904 compliant-*Flustix Plastic Free Trustmark.

The substrate or blank may be made of multiple layers. A coating may be applied to add adhesive capability to the surface to attach to opposing surface of the same substrate or blank. In discussing the substrate or material for the sake of brevity it is understood that it includes versions in which a coating was added to the substrate or material before the die cut. For example with respect to the board, the Delipac Oven Silk packaging board has a structure in which has the following layers in order: light coated ultra-smooth printing surface, chemical pulp (top layer), chemical pulp (under layer), chemical pulp+mechanical pulp (filler layer), chemical pulp (back layer), and barrier coating with heat seal application. The following tables provide additional description of the Delipac Oven Silk packaging board:

TECHNICAL DATE/PRODUCT SPECIFICATION

| | | | | Channel matrix | |
|---|---|---|---|---|---|
| | | | | Creasing groove rule widths | |
| | | Taber Stiffness | | Recommended: metal die tool | |
| GSM | Thickness | 15 [symbol] (T [symbol] -99) | | (If plastic, then reduce speed/pressures) | |
| (T 410 [symbol] ) | MICRONS μ | MD | CD | MD | CD |
| +/− 5% | (ISO 534: 1988 E) | (m/mm) | (m/mm) | (mm) | (mm) |
| 205 | 280 | 6.5 | 2.7 | 0.9 | 1.0 |
| 225 | 310 | 8.5 | 2.9 | 0.9 | 1.0 |
| 245 | 325 | 9.7 | 3.9 | 1.0 | 1.1 |
| 255 | 335 | 10.3 | 3.8 | 1.0 | 1.1 |
| 275 | 375 | 12.6 | 5.1 | 1.1 | 1.2 |
| 295 | 400 | 15.8 | 6.8 | 1.2 | 1.3 |
| 315 | 430 | 16.8 | 7.8 | 1.2 | 1.3 |
| 345* | 470 | 25.9 | 11.9 | 1.3 | 1.4 |
| 355* | 500 | 30.2 | 14.1 | 1.3 | 1.4 |

*Non standard, requires [symbol] [symbol]
indicates data missing or illegible when filed

| | | | |
|---|---|---|---|
| Moister content | 7.5 | % | 7.5 +/− .05 |
| T412 [symbol] 02 | | | |
| Roughness pps | Top | μ | Max 350 |
| ISO 5636-3 1992 | | | |
| Brightness-(ISO) | Top | % | 80 +/− 5 |
| ISO 2470-1977 (E) | | | |
| Internal bond strength | | g/m2 | Min 150 |
| (SCOTT) 569 pm 00 | | | |
| water absorption Cobb | Backside | g/m2 | 70 |
| (barrier side) | and | | |
| T441 [symbol] -04 180 sec gsm | Topside | | |
| Grease resistance | | [symbol] | K [symbol] level 12 |
| Hard sizing | | [symbol] | vegetable based |
| | | | starch |
| Moisture vapour tranefer rate | | g/m2 | Ave. 9.4 |
| (MVTR) | | | |
| ISO2528-2017-1023C | | | |
| RH 50% area 50 [symbol] | | | |
| Maximum [symbol] temperature | | ° C. | Max 220 |
| Heal-sealing gutde condition | Tap | Approx | 180° C. √ 3 bar |
| | | | pressure rapid |
| | | | dwell <1 second |
| Heal-sealing guide condition | Back | Approx | 170° C. √ 3 bar |
| | | | pressure rapid |
| | | | dwell <1 second |

[symbol]

[symbol]

indicates data missing or illegible when filed

Preferred paperboard is in the approximately 10 pt—17 pt thickness range or in the 10 pt to 24 pt range.

Recyclable, biodegradable and compostable, in the context of paperboard or natural fiber packaging products, is understood to those of ordinary skill in the art to refer to the commercially understood meaning of the terms under applicable rules in the United States for consumer (curbside) recycling. These relate to rules pertaining to manufacturer's being able to mark or specify that their products are recyclable, biodegradable or compostable. The above brands and websites demonstrate the usage of such terms and specify related certifications.

The structure of the assembled tray (see structure of illustrative trays in the FIGS.) is adapted to allow the trays to be nested in a vertical stack (a magazine), shipped, and de-nested during the process of receiving food or other material into the tray during the product production process. This is established at least by the slope of the peripheral walls or angled sidewalls descending towards the bottom of the tray that allow the trays to stack and nest within each other. The structure can be facilitated by the structure of the corners. This can provide quicker and more efficient production capabilities (e.g., the size, weight, and adaptation to food production can be important in the prepared food and packaging industry). For example, the nesting capability allows for the trays to be assembled offsite and shipped to the prepared food facility for manufacture.

Other types of boards that provide integrated support and packaging boards made from recyclable materials or nonrecyclable materials (or combination thereof) are contemplated.

It should be understood that the blank or die cut substrate from which the tray is assembled can be a single contiguous piece that is without holes or opening in the sidewalls or bottom surface of the tray to block or prevent the contents of the tray from leaking or exiting the tray. The material from which the tray is made preferably not water permeable and is water or liquid proof such that it can hold liquids in frozen or liquid states for prolonged periods without leaking or breaking. Some existing solutions involve an arrangement in which a paper tray is produced and an insert is formed and positioned in the paper tray for use by a consumer. In other words, the insert is the food carrier and in embodiments of the present invention, the tray as configured provides the structural support for at tray and the food consumption area without requiring such an insert. The disclosed trays are configured to avoid leaking (including being soaked so as to cause a leak or hole to be created) as a result of the illustrated described physical arrangements of the blank when assembled and without additional liners, surface treatments, and/or surface processes to form the receiving area that provides the leak protection.

The described trays are adapted to receive food or other content directly into the middle portion of the tray (touching the sidewall and bottom) where the material from which the board is made or formed is in direct contact for prolonged periods (such as in freezer) with the food or content supported by the tray. The tray is configured to operable for intended use without requiring an insert, fitting, or plastic layer. The tray can be produced with the paperboard by die cutting, folding, and sealing so at to be ready for receiving food content and shipped to customers.

The triangles at the triangular corner folds can depend on the desired radius and dimensions of the tray. The range of the number of triangles can be in the 2-6 range. For example, a maximum of 6.

Embodiment of the present invention are adapted for implementation in a various of food tray sizes including standard sizes such as #3 Tray (6.75 in×8.75 in×3 in, depth can vary from 1″-3″), #5 Tray (8.13 in×10.3 in×2.5 in, depth can vary from 2″-3″), and family pack (10.25″ in×12.375″ in×3″ in, depth can vary from 2″-3″).

As used herein, the term “about” refers to a range that is ±10% from the values recited within the context specifically used. Also, if “about” not specified in association with a number or range, it should be understood that it is contemplated. Every point in a range is also considered as having particular relevance without having to be explicitly expressed herein.

The words “may” or “can” are used to indicated that is a feature or characteristic but other implementations are contemplated (understood).

Although the disclosure herein has been described with reference to particular aspects, it is to be understood that these aspects are merely illustrative of the principles and applications of the present disclosure. It is therefore to be understood that numerous modifications may be made to the illustrative aspects and that other arrangements may be devised without departing from the spirit and scope of the present disclosure as defined by the appended claims. Therefore, embodiments of the present disclosure have not been described for limiting purposes.

What is claimed is:

1. A food tray, comprising a base portion, comprising:
a plurality of side walls, configured to form a receptacle for receiving one or more items; and
a plurality of corner portions, each corner portion comprising:
a plurality of triangular corner folds configured to cause each corner portion to have a generally rounded appearance; and
a plurality of cut extension portions extending from the plurality of triangular corner folds; and
an edge cover portion, secured to a top surface of the base portion along an outer perimeter of the base portion, wherein the edge cover portion is configured to be secured to the base portion along the plurality of cut extension portions, covering all or a portion of a top surface of the plurality of cut extension portions, wherein:
the base portion or the edge cover portion comprises a base substrate, and the base substrate comprises paper board adapted to be folded to form the food tray and is recyclable, compostable, and biodegradeable.

2. The food tray of claim 1, wherein:
the base portion includes a plurality of edge portions extending from the plurality of side walls, and the edge cover portion is configured to cover all or part of a top surface of the plurality of corner portions and the plurality of edge portions.

3. The food tray of claim 1, further comprising one or more outer flaps extending from the plurality of corner portions.

4. The food tray of claim 3, further comprising a securing means for securing each of the one or more outer flaps to an adjacent side wall, forming the receptacle.

5. The food tray of claim 1, further comprising a securing means for securing the edge cover portion to the base portion, wherein the securing means comprises one or more of:
an adhesive material;
a cohesive material;
a heat seal; and
an ultrasonic seal.

6. The food tray of claim 5, wherein the securing means comprises one or more materials which are compostable.

7. The food tray of claim 1, further comprising a lid portion secured to a top surface of the edge cover portion.

8. The food tray of claim 7, further comprising a securing means for securing the lid portion to the top surface of the edge cover portion, wherein the securing means comprises one or more of:
an adhesive material;
a cohesive material;
a heat seal; and
an ultrasonic seal.

9. The food tray of claim 8, wherein the securing means comprises one or more materials which are one or more of: recyclable; biodegradable; and compostable.

10. The food tray of claim 7, wherein the lid portion is configured to be removable from, and resealable to, the top surface of the edge cover portion.

11. The food tray of claim 1, wherein the base portion and the edge cover portion are one or more of: recyclable; biodegradable; and compostable.

12. The food tray of claim 1, wherein the base portion or the edge cover portion comprises:
a base substrate; and
a coating coupled to at least one surface.

13. The food tray of claim 12, wherein the base substrate comprises cellulose.

14. The food tray of claim 13, wherein the base substrate comprises solid bleached sulfate paperboard.

15. The food tray of claim 12, wherein the coating is configured to prevent the base substrate from absorbing one or more liquids.

16. The food tray of claim 15, wherein the coating comprises one or more materials which are compostable.

17. The food tray of claim 1, wherein the base portion is configured for use in one or more of:
an oven; and a microwave.

18. The food tray of claim 1, wherein the base portion is configured for use in one or more of:
a refrigerator; and a freezer.

19. A food tray, comprising a base portion, comprising:
a plurality of side walls, configured to form a receptacle for receiving one or more items; and
a plurality of corner portions, each corner portion comprising:
a plurality of triangular corner folds configured to cause each corner portion to have a generally rounded appearance; and
a plurality of cut extension portions extending from the plurality of triangular corner folds; and
an edge cover portion, secured to a top surface of the base portion along an outer perimeter of the base portion, wherein the edge cover portion is configured to be secured to the base portion along the plurality of cut extension portions, covering all or a portion of a top surface of the plurality of cut extension portions, wherein the base portion or the edge cover portion comprises a base substrate.

20. The food tray of claim 19, wherein:
the base portion includes a plurality of edge portions extending from the plurality of side walls, and the edge cover portion is configured to cover all or part of a top surface of the plurality of corner portions and the plurality of edge portions.

21. The food tray of claim 19, wherein the base portion or the edge cover portion comprises:
a base substrate; and
a coating coupled to at least one surface.

22. The food tray of claim 21, wherein the base substrate is paper.

23. The food tray of claim 21, wherein the base substrate comprises solid bleached sulfate paperboard (SBS).

24. The food tray of claim 23, wherein the base portion is configured for use in one or more of: an oven; and a microwave.

25. The food tray of claim 24, wherein the base portion is configured for use in one or more of: a refrigerator; and a freezer.

26. The food tray of claim 25, wherein the lid portion is perforated to provide a tear along an interior area of the lid.

27. The food tray of claim 19, wherein the perforated lid portion comprise a notch along an edge portion of the lid to pull and initiate the tearing of the lid.

28. The food tray of claim 19, wherein a card piece is attached to the bottom of the base portion that overhangs to allow the food tray to stand vertically.

29. The food tray of claim 19, wherein the lid portion comprise an extended lid that folds around and attaches to base portion to allow the food tray to stand vertically along the lid extension.

30. The food tray of claim 29, wherein the lid portion is perforated to provide a tear along an interior area of the lid.

31. The food tray of claim 1 further wherein at each bottom corner of the tray, there is a leak resistance structure comprising terminating a cut line of a sidewall a short distance from a vertex.

32. The food tray of claim 1 further wherein a plurality of leak resistance structures adapted to incorporate an offset at a terminating end of a cut line at a position a short distance away from a vertex of a corner.
